(19) United States
(12) Patent Application Publication
(10) Pub. No.: US 2025/0363734 A1
(43) Pub. Date: Nov. 27, 2025

(54) EFFECT PROCESSING METHOD, ELECTRONIC DEVICE AND STORAGE MEDIUM

(71) Applicant: Beijing Zitiao Network Technology Co., Ltd., Beijing (CN)

(72) Inventors: Jiaxin MA, Beijing (CN); Wentao LIU, Beijing (CN); Minhui XIE, Beijing (CN); Bo WANG, Beijing (CN)

(21) Appl. No.: 19/217,374

(22) Filed: May 23, 2025

(30) Foreign Application Priority Data
May 24, 2024 (CN) 202410659370.X

(51) Int. Cl. G06T 17/00; G06T 5/50

(52) U.S. Cl. CPC G06T 17/00; G06T 5/50; G06T 2207/20221

(57) ABSTRACT

Embodiments of the present disclosure provide an effect processing method, an electronic device, and a storage medium. The method includes: obtaining, in response to an effect generation request, a plurality of first images; determining a plurality of second images corresponding to the plurality of first images, respectively, where the plurality of second images are used to present shooting effects of image contents of the plurality of first images under different shooting parameters in a three-dimensional space; generating a video according to the plurality of second images, and displaying the video.

### CROSS-REFERENCE TO RELATED APPLICATION

The present application claims priority of Chinese Patent Application No. 202410659370.X, filed on May 24, 2024, and the entire content disclosed by the Chinese patent application is incorporated herein by reference as part of the present application for all purposes under the U.S. law.

### TECHNICAL FIELD

Embodiments of the present disclosure relate to computer application technology, and in particular, to an effect processing method and apparatus, an electronic device, a storage medium and a program product.

### BACKGROUND

In the field of image processing, it has become one of the image processing methods favored by users to improve the display effect of images by performing effect processing on the images.

In the related art, when performing effect processing on images, it is often done on a single image, and the effect is generally achieved by adding or modifying the image content on a plane image. This makes the image display effect obtained by this effect processing method tend to be similar in most scenarios, which results in a monotonous overall display effect of the image and a lack of fun, and affecting the user experience.

### SUMMARY

The present disclosure provides an effect processing method and apparatus, an electronic device, a storage medium and a program product, to enrich the presentation effect of second images.

In a first aspect, an embodiment of the present disclosure provides an effect processing method, which includes:

obtaining, in response to an effect generation request, a plurality of first images;

determining a plurality of second images corresponding to the plurality of first images, respectively, where the plurality of second images are used to present shooting effects of image contents of the plurality of first images under different shooting parameters in a three-dimensional space; and

generating a video according to the plurality of second images, and displaying the video.

In a second aspect, an embodiment of the present disclosure provides an effect processing apparatus, which includes:

an effect generation request module, configured to obtain, in response to an effect generation request, a plurality of first images;

a second image determining module, configured to determine a plurality of second images corresponding to the plurality of first images, respectively, where the second images are used to present shooting effects of image contents of the first images under different shooting parameters in a three-dimensional space; and

a video display module, configured to generate a video according to the plurality of second images, and display the video.

In a third aspect, an embodiment of the present disclosure provides an electronic device, which includes:

one or a plurality of processors; and

a memory, configured to store one or a plurality of programs,

where the one or plurality of programs, when executed by the one or plurality of processors, cause the one or plurality of processors to implement the effect processing method provided by any embodiment of the present disclosure.

In a fourth aspect, an embodiment of the present disclosure provides a storage medium containing computer-executable instructions, where the computer-executable instructions, when executed by a computer processor, are used to execute an effect processing method provided by any embodiment of the present disclosure.

In a fifth aspect, an embodiment of the present disclosure provides a computer program product, the computer program product includes a computer program, and the computer program, and when executed by a processor, implements the effect processing method provided by any embodiment of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a flowchart of an effect processing method provided by an embodiment of the present disclosure;

FIG. 2 is a flowchart of another effect processing method provided by an embodiment of the present disclosure;

FIG. 3 is a flowchart of another effect processing method provided by an embodiment of the present disclosure;

FIG. 4 is a schematic structural diagram of an effect processing apparatus provided by an embodiment of the present disclosure; and

FIG. 5 is a schematic structural diagram of an electronic device provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

Names of messages or information exchanged among multiple apparatuses in the embodiments of the present disclosure are merely used for illustrative purposes, and are not used to limit the scope of these messages or information.

It is to be understood that before using technical solutions disclosed in various embodiments of the present disclosure, a user should be notified of the type, scope of use, use scene and the like of personal information involved in the present disclosure in an appropriate manner according to relevant laws and regulations, and authorization from the user should be acquired.

For example, in response to receiving an active request from a user, prompt information is sent to the user to explicitly remind the user that the requested operation requires acquisition and use of personal information of the user. Therefore, the user can independently choose, according to the prompt information, whether to provide personal information to software or hardware, such as an electronic device, an application program, a server, or a storage medium, etc., for executing operations of the technical solution of the present disclosure.

In an optional but non-limiting embodiment, in response to receiving the active request from the user, the manner in which the prompt information is sent to the user may be, for example, in the form of a pop-up window in which the prompt information may be presented in text. Additionally, the pop-up window may also carry a selection control for the user to select “agree” or “disagree” to determine whether to provide personal information to the electronic device.

It is to be understood that the preceding process of notifying the user and obtaining authorization from the user is illustrative only and does not limit the embodiments of the present disclosure, and that other manners complying with relevant laws and regulations may also be applied to the embodiments of the present disclosure. It is to be understood that the preceding process of notifying the user and obtaining authorization from the user is illustrative only and does not limit the embodiments of the present disclosure, and that other manners complying with relevant laws and regulations may also be applied to the embodiments of the present disclosure.

It is to be understood that data (including, but not limited to, the data itself and acquisition or use of the data) involved in the technical solution should comply with corresponding laws and regulations and relevant provisions.

According to the technical solution of the embodiment of the present disclosure, a plurality of first images are obtained in response to an effect generation request, so that batch processing of the plurality of first images is supported; a plurality of second images corresponding to the plurality of first images are respectively determined, and the plurality of second images are used to present shooting effects of image contents of the first images under different shooting parameters in a three-dimensional space, so that the second images can present a stereoscopic effect compared with the first images; a video is generated according to the plurality of second images, and the video is displayed, so that the technical problem that the display effect of the images is monotonous due to the effect processing mode of processing a single image and processing on a plane image in the related art is solved, the combination display of multiple second images is realized, the fun of effect processing is increased, and the display effect of the video is enriched.

FIG. 1 is a flowchart of an effect processing method provided by an embodiment of the present disclosure. The embodiment of the present disclosure is applicable to the case of generating second images with stereoscopic display effect through multiple images. The method can be executed by an effect processing apparatus. The apparatus can be implemented in the form of software and/or hardware, or alternatively, can be implemented by an electronic device. The electronic device can be a mobile terminal, a PC end or a server, etc.

As shown in FIG. 1, the method in the present embodiment specifically includes:

S110: Obtaining, in response to an effect generation request, a plurality of first images.

The effect generation request is used to requesting displaying of the effect corresponding to the first images, or to request starting effect processing on the first images. The first images can be understood as the images on which effect processing is to be performed, so the first image may also be referred to as an image to be processed in the following. Optionally, the effect generation request includes one or more request parameters, such as effect related parameters corresponding to the target effect to be added and/or image related parameters of the images to be processed (i.e., the first images). The effect related parameters may include effect representation and/or effect type, etc. The image related parameters include one or more selected from the parameters such as image itself, image identifier, image number and image size.

In the embodiment of the present disclosure, there are many ways to initiate the effect generation request. Illustratively, an effect generation request can be generated in response to a control trigger operation acting on a preset effect generation control; or, an effect generation request is generated in the case where preset trigger information (action information or speech information, etc.) is detected; or an effect generation request is generated in response to a preset trigger event (for example, a preset time is reached or the image content of the first image includes a preset content, etc.), and so on.

After the effect generation request is received, a plurality of images to be processed (i.e., the first images) can be obtained. Specifically, the way to obtain a plurality of images to be processed can include, but is not limited to, at least one of the following: in the case where the effect generation request contains the Universal Resource Locator (URL) of the images to be processed, the images to be processed are downloaded according to the URL; in the case where the effect generation request contains the images to be processed, the images to be processed are obtained from the effect generation request; in the case where the effect generation request does not contain the images to be processed but contains image generation information (such as one or more pieces of information such as size, color, content and style, etc.), the images to be processed can be generated according to the image generation information; images are retrieved from an image database or file system, and so on.

As an optional implementation of the embodiment of the present disclosure, an image capture interface can be displayed, where the image capture interface includes an image shooting control and an image uploading control; further, a plurality of images to be processed can be determined in response to the control trigger operation acting on the image shooting control and/or the image uploading control. In short, the plurality of images to be processed can include only real-time captured images, can include only uploaded images, and can also include both a first number of real-time captured images and a second number of uploaded images. The first number and the second number may be the same or different.

S120: Determining a plurality of second images corresponding to the plurality of first images, respectively, where the plurality of second images are used to present shooting effects of image contents of the plurality of first images under different shooting parameters in a three-dimensional space.

The second images can be understood as images obtained by performing effect processing on the first images using an effect processing mode corresponding to the target effect, so the second image may also be referred to as an effect image in the following. In the embodiment of the present disclosure, the correspondence between the effect images (i.e., the second images) and the images to be processed (i.e., the first images) can be one-to-one correspondence, and can also be plural-to-one or one-to-plural correspondence. As an optional technical solution of the embodiment of the present disclosure, the effect images corresponding to each image to be processed are determined respectively, that is, each image to be processed can be subjected to effect processing separately, thereby obtaining the effect image(s) corresponding to each image to be processed.

In the embodiment of the present disclosure, the effect images (i.e., the second images) are specifically used to present shooting effects of image contents of the images to be processed (i.e., the first images) under different shooting parameters in a three-dimensional space. That is, the effect images are used to present the image contents obtained by shooting image contents of the images to be processed at different viewpoints in a three-dimensional space, so as to present the images to be processed in a two-dimensional space with a three-dimensional visual effect. Optionally, the effect image can be obtained by shooting a three-dimensional model corresponding to the image to be processed through a camera in the model space under different shooting parameters. The three-dimensional model corresponding to the image to be processed can be a preset three-dimensional model or a three-dimensional model constructed based on image content of the image to be processed.

The shooting parameters can be understood as the parameters used by the camera when shooting, especially those parameters associated with the display effect of the image shot by the target camera. Illustratively, the shooting parameters at least include camera pose and/or shooting duration, etc. In the embodiment of the present disclosure, the target camera can be controlled to move according to a preset movement trajectory, where the camera pose and/or shooting duration of the target camera at different trajectory points on the movement trajectory can be the same or different.

It can be understood that the presentation effect of the effect image is associated with the size of the shooting field of view. In order to match the display effect of the effect image with the display region of the display device, the shooting parameters can further include a shooting field of view. Further, the size of the shooting field of view can be associated with the width-height ratio of the image to be processed (i.e., the first image). That is, the size of the shooting field of view can be dynamically adjusted according to the width-height ratio of the image to be processed. Because the three-dimensional model has a stereoscopic structure, the shooting field of view of the camera in the model space can be adjusted to control the display effect of the effect image.

Optionally, in the case where the width-height ratio of the image to be processed is less than or equal to a preset ratio, the size of the shooting field of view is positively correlated with the width-height ratio of the image to be processed. That is, the smaller the width-height ratio of the image to be processed, the smaller the shooting field of view. For example, for the image to be processed with a large height-width ratio (i.e., a small width-height ratio), the longer in the vertical direction the image is in terms of visualization effect, the more obvious the black edges that need to be filled around the image. In this case, the size of the shooting field of view is set according to the width-height ratio of the image to be processed. Because the image display will be enlarged when the shooting field of view is reduced, this setting can reduce the display of black edges around the effect image.

S130: Generating a video according to the plurality of second images, and displaying the video.

In the embodiment of the present disclosure, there may be various ways to generate a video according to the plurality of second images. That is, the video is generated according to the plurality of effect images (i.e., second images), so the generated video may also be referred to as an effect video in the following. Illustratively, the generating a video according to the plurality of second images can include: fusing and/or splicing the plurality of the second images to obtain at least one target image, and generating a video based on the target image; or, determining the display order and display time of each effect image, respectively, and generating a video according to the display order and display time of the plurality of second images, and so on. For example, in the video, the plurality of the second images can be played in turn.

It should be noted that the plurality of second images used to generate the video can be part or all of the determined second images.

Optionally, displaying the video can be displaying a preview effect of the effect video. Specifically, part of the video content of the effect video can be displayed, or all of the content of the effect video can be displayed.

Considering that it takes some time to perform effect processing on the plurality of images to be processed, in order to enhance the user's experience of using effects, optionally, after responding to the effect generation request and before displaying the effect video, the method further includes: displaying a target interface, where at least part of the image content of at least one image to be processed (i.e., the first image) is displayed on the target interface. In the embodiment of the present disclosure, the target interface can be understood as an effect loading interface or a transition interface. One or more images to be processed can be displayed on the target interface, or part of image content(s) of one or more images to be processed can be displayed on the target interface. For example, a previous image to be processed (i.e., a previous first image) that is set by the user is rendered on the target interface. Because the content displayed on the target interface is related to effect processing, it can achieve a smooth transition from the setting of the image to be processed to the effect video while the user is waiting for the effect video to be generated, and can enrich the display content of the interface.

As an optional implementation of the embodiment of the present disclosure, the displaying a target interface can specifically include: processing, in a case where image resolution is inconsistent with device resolution of a display device, the images to be processed by using a preset processing mode, and rendering the images to be processed that have been processed on the target interface of the display device, where the preset processing mode includes interpolation processing and/or cropping processing. Illustratively, according to the device resolution of the display device, for the image to be processed having a landscape orientation, the display regions on the upper and lower sides are filled with preset contents; for the image to be processed having a portrait orientation, the display regions on the left and right sides are filled with preset contents (such as black edges), and so on. The advantage of this setting is that it can fully display the image content of the image to be processed while optimizing the overall display effect of the target interface.

According to the technical solution of the embodiment of the present disclosure, a plurality of images to be processed are obtained in response to an effect generation request, so that batch processing of the plurality of images to be processed is supported; a plurality of effect images (i.e., a plurality of second images) corresponding to the plurality of images to be processed are respectively determined, and the plurality of effect images are used to present shooting effects of image contents of the images to be processed under different shooting parameters in a three-dimensional space, so that the effect images can present a stereoscopic effect compared with the images to be processed; an effect video is generated according to the plurality of effect images, and the effect video is displayed, so that the technical problem that the display effect of the images is monotonous due to the effect processing mode of processing a single image and processing on a plane image in the related art is solved, the combination display of multiple effect images is realized, the fun of effect processing is increased, and the display effect of the effect video is enriched.

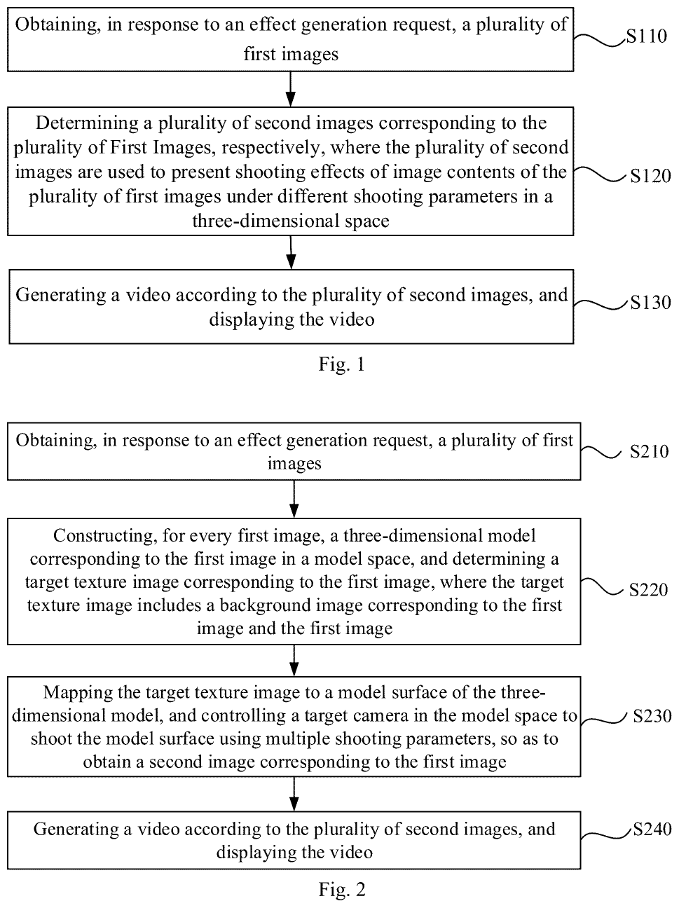

FIG. 2 is a flowchart of another effect processing method provided by an embodiment of the present disclosure. The technical solution of the present embodiment further refines the generation mode of the effect images on the basis of the above embodiment. Optionally, the determining a plurality of effect images corresponding to the plurality of images to be processed, respectively, includes: determining, for every single image to be processed, a background image corresponding to the image to be processed, and constructing a three-dimensional model corresponding to the image to be processed in a model space; splicing the background image and the image to be processed to obtain a target texture image, and mapping the target texture image to a model surface of the three-dimensional model; controlling a target camera in the model space to shoot the model surface using multiple shooting parameters, so as to obtain an effect image corresponding to the image to be processed. The specific implementation can refer to the description of the present embodiment. The technical features same as or similar to those in the above embodiment are not repeatedly described here.

As shown in FIG. 2, the method of the present embodiment can specifically include:

S210: Obtaining, in response to an effect generation request, a plurality of first images.

S220: Constructing, for every single first image, a three-dimensional model corresponding to the first image in a model space, and determining a target texture image corresponding to the first image, where the target texture image includes a background image corresponding to the first image and the first image.

As described above, in the embodiment of the present disclosure, effect processing can be separately performed on each image to be processed (i.e., each first image) to obtain effects images. In order to reflect the stereoscopic sense, the background content corresponding to the image to be processed can be segmented to obtain a background image, so as to highlight the layering sense between the foreground content and the background content in the generated effect image. It should be noted that the background image can be an image with the same size as the image to be processed. From the visualization point of view, the background image can be an image obtained by removing the foreground region in the image to be processed and then performing image inpainting according to the background content. In other words, the background image can be an image with the background content corresponding to the foreground content being completed.

It should be noted that there are many ways to determine the background image corresponding to the image to be processed. Illustratively, the background image can be obtained by performing background segmentation on the image to be processed through a pre-trained image segmentation model, where the image segmentation model can be a deep learning model (such as a convolutional neural network, etc.) or the like. Or, a mask image of the image to be processed is determined, the background content in the image to be processed is segmented according to the mask image, and image inpainting is performed on the image region corresponding to the foreground content in the image to be processed according to the background content, so as to obtain a background image, where the mask image is a binary image for distinguishing the background region and the foreground region in the image to be processed.

The three-dimensional model corresponding to the image to be processed can be understood as a model for presenting the spatial position (spatial result) corresponding to the image content of the image to be processed. In other words, the three-dimensional model corresponding to the image to be processed will simulate and construct, according to the image content of the image to be processed, the three-dimensional structure of the original spatial representation of the image content. Specifically, the constructing a three-dimensional model corresponding to the image to be processed in a model space can include: determining, according to the image content of the image to be processed, depth information corresponding to each pixel point, respectively, and constructing the three-dimensional model corresponding to the image to be processed in the model space according to the depth information. The model space can be understood as local space. The target camera can be understood as a virtual camera used for image rendering in the local space. Illustratively, semantic segmentation can be performed on the image content of the image to be processed, so as to identify the image subject contained in the image to be processed; and depth information (e.g., depth value) can be set for each image subject by taking a single image subject or image subjects of the same type as a unit, and the depth information corresponding to each pixel point in the image to be processed is determined through the depth information of each image subject. Furthermore, a three-dimensional grid corresponding to the pixel points in the image to be processed is constructed in the model space according to the depth information, and a three-dimensional model corresponding to the image to be processed is constructed according to the three-dimensional grid. By adopting this technical solution, a three-dimensional model can be generated pertinently according to the image content of the image to be processed, so that the three-dimensional model is more in line with the image content of the image to be processed, thereby ensuring the three-dimensional presentation effect of the image content of the image to be processed.

Optionally, the determining a target texture image corresponding to the image to be processed includes: determining a background image corresponding to the first image (i.e., image to be processed), and splicing the background image and the first image to obtain the target texture image. For example, the background image may be on the left and the first image may be on the right. Considering that in some scenarios, the image to be processed is usually compressed for the sake of transmission rate, if the compressed image to be processed is used when generating the effect image, the sampling result will be poor in accuracy. In the technical solution of the embodiment of the present disclosure, the resolution of the generated effect image can be effectively improved by using the original image to be processed.

S230: Mapping the target texture image to a model surface of the three-dimensional model, and controlling a target camera in the model space to shoot the model surface using multiple shooting parameters, so as to obtain a second image corresponding to the first image.

Specifically, the target texture image can be mapped onto the model surface of the three-dimensional model according to the correspondence between each pixel point in the target texture image and each three-dimensional grid (grid point) in the three-dimensional model. The correspondence between each pixel point in the target texture image and each three-dimensional grid (grid point) in the three-dimensional model can be determined and recorded in the procedure of constructing the model. Then, the target camera in the model space is controlled to move according to a set movement trajectory, and to shoot the model surface, so that multiple shooting parameters are adopted to shoot the model surface, thereby obtaining an effect image (i.e., a second image) corresponding to the image to be processed. By adopting this technical solution, the static image can be processed into the camera movement effect with multi-view shooting.

S240: Generating a video according to the plurality of second images, and displaying the video.

According to the technical solution of the embodiment of the present disclosure, by determining, for a single image to be processed, a background image corresponding to the image to be processed, the layering sense between the foreground content and the background content can be highlighted in the generated effect image (i.e., the generated second image); then, by constructing a three-dimensional model corresponding to the image to be processed in a model space, a three-dimensional model can be generated pertinently according to the image content of the image to be processed, so that the three-dimensional model is more in line with the image content of the image to be processed, thereby ensuring the three-dimensional presentation effect of the image content of the image to be processed; and then, by splicing the background image and the image to be processed to obtain a target texture image and mapping the target texture image to a model surface of the three-dimensional model, the image to be processed becomes stereoscopic from a plane and can support multi-view rendering; finally, a target camera in the model space is controlled to shoot the model surface using multiple shooting parameters to obtain an effect image corresponding to the image to be processed, thus realizing the stereoscopic display of the image to be processed and enriching the display effect of effect.

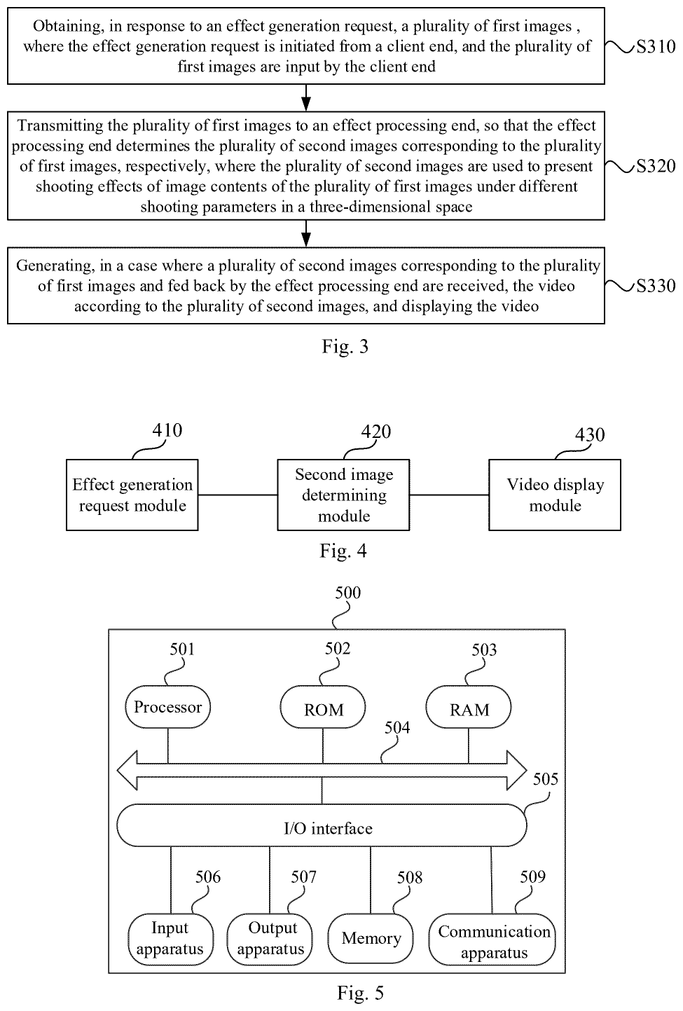

FIG. 3 is a flowchart of another effect processing method provided by an embodiment of the present disclosure. The technical solution of the present embodiment further refines the implementation of the effect processing mode on the basis of the above embodiments. Optionally, the effect generation request is initiated from a client end; the plurality of images to be processed (i.e., the plurality of first images) are input by the client end; the determining a plurality of effect images (i.e., a plurality of second images) corresponding to the plurality of images to be processed, respectively, includes: transmitting the plurality of images to be processed to an effect processing end, so that the effect processing end determines the plurality of effect images corresponding to the plurality of images to be processed, respectively; further, the generating an effect video according to the plurality of effect images includes: generating, in a case where a plurality of effect images corresponding to the plurality of images to be processed and fed back by the effect processing end are received, the effect video according to the plurality of effect images, and displaying the effect video. The specific implementation can refer to the description of the present embodiment. The technical features same as or similar to those in the above embodiment are not repeatedly described here.

As shown in FIG. 3, the method of the present embodiment can specifically include:

S310: Obtaining, in response to an effect generation request, a plurality of first images, where the effect generation request is initiated from a client end, and the plurality of first images are input by the client end.

In the embodiment of the present disclosure, the effect processing can be implemented at the client end, and can also be implemented at the effect processing end. Different from the effect processing end, the client end can be a device or software that directly interacts with the user for effects; specifically, the client end can be a device or software that initiates the effect generation request and receives the effect processing result. The effect processing end can be understood as a device that communicates with the client end and can perform effect processing operation on the image to be processed input by the client in response to the effect generation request of the client end.

S320: Transmitting the plurality of first images to an effect processing end, so that the effect processing end determines the plurality of second images corresponding to the plurality of first images, respectively, where the plurality of second images are used to present shooting effects of image contents of the plurality of first images under different shooting parameters in a three-dimensional space.

Considering that the performance and computing power space of the client end are often limited, in the embodiment of the present disclosure, the plurality of images to be processed (i.e., the plurality of first images) can be transmitted to the effect processing end, so that the effect processing end can respectively determine the plurality of effect images (i.e., the plurality of second images) corresponding to the plurality of images to be processed, which can reduce the memory occupation of the client end and improve the performance of the client end. Moreover, effect processing can be performed at the effect processing end, and the reuse of the effect processing algorithm and tool can be realized for the effect generation requests of the same effect initiated from different client ends.

Optionally, the transmitting the plurality of images to be processed to an effect processing end includes: initiating, in a case where a count of the images to be processed exceeds a preset transmission number, an image transmission request according to the preset transmission number, so as to transmit the plurality of the images to be processed to the effect processing end, where a latter image transmission request is initiated after receiving the effect images corresponding to the images to be processed transmitted according to a former image transmission request. The preset transmission number can be a transmission number set in advance according to factors such as network transmission and device performance, etc. The advantage of this setting is that it cannot only ensure the efficiency of effect processing, but also ensure the smooth execution of effect processing and improve the success rate of obtaining effect images.

In other words, at most, a preset transmission number of images to be processed are sent in one image transmission request. In the case where the number of images to be processed exceeds the preset transmission number, the plurality of images to be processed can be sent in batches according to the preset transmission number. For example, at most two images to be processed can be sent in one image transmission request, and in the case where the client end has received the effect images corresponding to the two images to be processed that have been sent, an image transmission request can be initiated again, and the transmission of all of the images to be processed can be completed by initiating image transmission requests for multiple times.

Specifically, the transmitting the plurality of images to be processed to an effect processing end includes: storing the plurality of images to be processed in a target array, determining the index (storage location) corresponding to each image to be processed, and sending the plurality of images to be processed to the effect processing end (e.g., a server end) frame by frame according to the storage locations of the images to be processed in the target array and the preset transmission number corresponding to one image transmission request, and simultaneously sending the indexes corresponding to the images to be processed as image identifiers to the effect processing end. In the case where the effect images fed back by the effect processing end are received, the effect images are stored in the target array according to the indexes corresponding to the images to be processed.

S330: Generating, in a case where a plurality of second images corresponding to the plurality of first images and fed back by the effect processing end are received, the video according to the plurality of second images, and displaying the video.

Specifically, in the case where a preset image number of effect images (i.e., the second images) corresponding to the plurality of images to be processed (i.e., the plurality of first images) and fed back by the effect processing end are received, the operation of generating a video (i.e., an effect video) according to the plurality of effect images is performed, where the preset image number can be set according to actual situations, and is not specifically limited here. For example, the preset image number can be the same as the number of images to be processed, or it can be a preset fixed value or the like. The advantage of this setting is that it can ensure the smooth generation of the effect video and the content integrity of the generated effect video.

According to the technical solution of the embodiment of the present disclosure, the effect generation request is initiated from a client end and the images to be processed are input by the client end, and the client end can directly interact with the user, so that the audience of the effect generation method is wider and the operation is more convenient; by transmitting a plurality of images to be processed to the effect processing end, the effect processing end can respectively determine a plurality of effect images corresponding to the plurality of images to be processed, so that the memory occupation of the client end can be reduced, the performance of the client end can be improved, and moreover, compared with the mode of sending one image to be processed for one request and requesting again after the effect image corresponding to the image to be processed is returned, by means of sending a plurality of images to be processed concurrently to the effect processing end for one request, the interactive link of effect processing is shortened and the efficiency of effect processing is improved; further, in the case where a plurality of effect images corresponding to the plurality of images to be processed and fed back by the effect processing end, an effect video is generated according to the plurality of the effect images, and the effect video is displayed, so that the smooth generation of the effect video can be effectively guaranteed.

FIG. 4 is a schematic structural diagram of an effect processing apparatus provided by an embodiment of the present disclosure. As shown in FIG. 4, the apparatus includes an effect generation request module 410, a second image determining module 420 and a video display module 430. The effect generation request module 410 is configured to obtain, in response to an effect generation request, a plurality of first images; the second image determining module 420 is configured to determine a plurality of second images corresponding to the plurality of first images, respectively, where the second images are used to present shooting effects of image contents of the first images under different shooting parameters in a three-dimensional space; the video display module 430 is configured to generate a video according to the plurality of second images, and display the video.

According to the technical solution of the embodiment of the present disclosure, through the effect generation request module 410, a plurality of first images are obtained in response to an effect generation request, so that batch processing of the plurality of first images is supported; through the second image determining module 420, a plurality of second images corresponding to the plurality of first images are respectively determined, and the plurality of second images are used to present shooting effects of image contents of the first images under different shooting parameters in a three-dimensional space, so that the second images can present a stereoscopic effect compared with the first images; through the video display module 430, a video is generated according to the plurality of second images, and the video is displayed, so that the technical problem that the display effect of the images is monotonous due to the effect processing mode of processing a single image and processing on a plane image in the related art is solved, the combination display of multiple second images is realized, the fun of effect processing is increased, and the display effect of the video is enriched.

On the basis of the above optional technical solutions, optionally, the second image determining module 420 includes a three-dimensional model construction unit and a texture image shooting unit. The three-dimensional model construction unit is configured to construct, for every single first image, a three-dimensional model corresponding to the first image in a model space, and determine a target texture image corresponding to the first image, where the target texture image includes a background image corresponding to the first image and the first image; the texture image shooting unit is configured to map the target texture image to a model surface of the three-dimensional model, and control a target camera in the model space to shoot the model surface using multiple shooting parameters, so as to obtain a second image corresponding to the first image.

On the basis of the above optional technical solutions, optionally, the three-dimensional model construction unit is specifically configured to determine a background image corresponding to the first image, and splice the background image and the first image to obtain the target texture image.

On the basis of the above optional technical solutions, optionally, the three-dimensional model construction unit is specifically configured to determine, according to the image content of the first image, depth information corresponding to each pixel point, respectively, and construct the three-dimensional model corresponding to the first image in the model space according to the depth information.

On the basis of the above optional technical solutions, optionally, the shooting parameters include a shooting field of view, and a size of the shooting field of view is associated with a width-height ratio of the first image.

On the basis of the above optional technical solutions, optionally, in the case where the width-height ratio of the first image is less than or equal to a preset ratio, the size of the shooting field of view is positively correlated with the width-height ratio of the first image.

On the basis of the above optional technical solutions, optionally, the effect generation request is initiated from a client end; the plurality of first images are input by the client end; accordingly, the second image determining module 420 is specifically configured to transmit the plurality of first images to an effect processing end, so that the effect processing end determines the plurality of second images corresponding to the plurality of first images, respectively; the video display module 430 is specifically configured to generate, in the case where a plurality of second images corresponding to the plurality of first images and fed back by the effect processing end are received, the video according to the plurality of second images, and display the video.

On the basis of the above optional technical solutions, optionally, the second image determining module 420 is further configured to initiate, in the case where a count of the first images exceeds a preset transmission number, an image transmission request according to the preset transmission number, so as to transmit the plurality of the first images to the effect processing end, where a latter image transmission request is initiated after receiving the second images corresponding to the first images transmitted according to a former image transmission request.

On the basis of the above optional technical solutions, optionally, the effect processing apparatus further includes a target interface display module. The target interface display module is configured to display, after the effect generation request is responded and before the video is displayed, a target interface, where at least part of the image content of at least one first image is displayed on the target interface.

On the basis of the above optional technical solutions, optionally, the target interface display module is specifically configured to process, in the case where image resolution is inconsistent with device resolution of a display device, the first images by using a preset processing mode, and render the first images that have been processed on the target interface of the display device, where the preset processing mode includes interpolation processing and/or cropping processing.

The effect processing apparatus provided by the embodiment of the present disclosure can execute the effect processing method provided by any embodiment of the present disclosure, and has corresponding functional modules for executing the method and corresponding beneficial effects.

It is worth noting that each unit and module included in the above apparatus is only divided according to functional logic, but it is not limited to the above division, as long as the corresponding functions can be realized; in addition, the specific names of each functional unit are only for the convenience of distinguishing each other, and are not used to limit the protection scope of the embodiment of the present disclosure.

FIG. 5 is a schematic structural diagram of an electronic device provided by an embodiment of the present disclosure. Hereinafter, referring to FIG. 5, it shows a schematic structural diagram of an electronic device 500 (e.g., a terminal device or a server in FIG. 5) suitable for implementing the embodiment of the present disclosure. The terminal device in the embodiment of the present disclosure can include, but is not limited to, a mobile terminal such as a mobile phone, a laptop computer, a digital broadcast receiver, a personal digital assistant (PDA), a portable android device (PAD), a portable media player (PMP), a vehicle-mounted terminal (e.g., vehicle-mounted navigation terminal), etc., and a fixed terminal such as a digital television (TV), a desktop computer, etc. The electronic device shown in FIG. 5 is merely an example, and should not bring any limitation to the function and application scope of the embodiment of the present disclosure.

As shown in FIG. 5, the electronic device 500 may include a processor (such as a central processing unit, and a graphics processor) 501, it may execute various appropriate actions and processes according to a program stored in a read-only memory (ROM) 502 or a program loaded from a memory 508 to a random access memory (RAM) 503. In RAM 503, various programs and data required for operations of the electronic device 500 are also stored. The processor 501, ROM 502, and RAM 503 are connected to each other by a bus 504. An input/output (I/O) interface 505 is also connected to the bus 504.

Typically, the following apparatuses may be connected to the I/O interface 505: an input apparatus 506 such as a touch screen, a touchpad, a keyboard, a mouse, a camera, a microphone, an accelerometer, and a gyroscope; an output apparatus 507 such as a liquid crystal display (LCD), a loudspeaker, and a vibrator; a memory 508 such as a magnetic tape, and a hard disk drive; and a communication apparatus 509. The communication apparatus 509 may allow the electronic device 500 to wireless-communicate or wire-communicate with other devices so as to exchange data. Although FIG. 5 shows the electronic device 500 with various apparatuses, it should be understood that it is not required to implement or possess all the apparatuses shown. Alternatively, it may implement or possess the more or less apparatuses.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 509, or installed from the memory 508, or installed from ROM 502. When the computer program is executed by the processor 501, the above functions defined in the embodiments of the present disclosure are executed.

Names of messages or information exchanged among multiple apparatuses in the embodiments of the present disclosure are merely used for illustrative purposes, and are not used to limit the scope of these messages or information.

The electronic device provided by the embodiment of the present disclosure belongs to the same inventive concept as the effect processing method provided by the above embodiment, and the technical details not provided in this embodiment can be found in the above embodiment, and this embodiment has the same beneficial effects as the above embodiment.

An embodiment of the present disclosure further provides a computer-readable storage medium, on which a computer program is stored; when the computer program is executed by a processor, the effect processing method provided by the above embodiment is implemented.

It should be noted that the above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-described computer-readable medium may be included in the above-described electronic device; or may also exist alone without being assembled into the electronic device.

The computer-readable medium carries one or more programs that, when executed by the electronic device, cause the electronic device to: obtain, in response to an effect generation request, a plurality of first images; determine a plurality of second images corresponding to the plurality of first images, respectively, where the plurality of second images are used to present shooting effects of image contents of the plurality of first images under different shooting parameters in a three-dimensional space; generate a video according to the plurality of second images, and display the video.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Herein, the name of the unit does not constitute a limitation for the unit itself in some cases.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, [Example 1] provides an effect processing method, which includes: obtaining, in response to an effect generation request, a plurality of first images; determining a plurality of second images corresponding to the plurality of first images, respectively, where the plurality of second images are used to present shooting effects of image contents of the plurality of first images under different shooting parameters in a three-dimensional space; generating a video according to the plurality of second images, and displaying the video.

According to one or more embodiments of the present disclosure, [Example 2] provides the method of Example 1, further including:

optionally, the determining a plurality of second images corresponding to the plurality of first images, respectively, includes: constructing, for every single first image, a three-dimensional model corresponding to the first image in a model space, and determining a target texture image corresponding to the first image, where the target texture image includes a background image corresponding to the first image and the first image; mapping the target texture image to a model surface of the three-dimensional model, and controlling a target camera in the model space to shoot the model surface using multiple shooting parameters, so as to obtain a second image corresponding to the first image.

According to one or more embodiments of the present disclosure, [Example 3] provides the method of Example 2, further including:

optionally, the determining a target texture image corresponding to the first image includes: determining a background image corresponding to the first image, and splicing the background image and the first image to obtain the target texture image.

According to one or more embodiments of the present disclosure, [Example 4] provides the method of Example 2, further including:

optionally, the constructing a three-dimensional model corresponding to the first image in a model space includes: determining, according to the image content of the first image, depth information corresponding to each pixel point, respectively, and constructing the three-dimensional model corresponding to the first image in the model space according to the depth information.

According to one or more embodiments of the present disclosure, [Example 5] provides the method of Example 1, further including:

optionally, the shooting parameters include a shooting field of view, and a size of the shooting field of view is associated with a width-height ratio of the first image.

According to one or more embodiments of the present disclosure, [Example 6] provides the method of Example 5, further including:

optionally, in a case where the width-height ratio of the first image is less than or equal to a preset ratio, the size of the shooting field of view is positively correlated with the width-height ratio of the first image.

According to one or more embodiments of the present disclosure, [Example 7] provides the method of Example 1, further including:

optionally, the effect generation request is initiated from a client end; the plurality of first images are input by the client end; the determining a plurality of second images corresponding to the plurality of first images, respectively, includes: transmitting the plurality of first images to an effect processing end, so that the effect processing end determines the plurality of second images corresponding to the plurality of first images, respectively; the generating a video according to the plurality of second images includes: generating, in a case where a plurality of second images corresponding to the plurality of first images and fed back by the effect processing end are received, the video according to the plurality of second images, and displaying the video.

According to one or more embodiments of the present disclosure, [Example 8] provides the method of Example 7, further including:

optionally, the transmitting the plurality of first images to an effect processing end includes: initiating, in a case where a count of the first images exceeds a preset transmission number, an image transmission request according to the preset transmission number, so as to transmit the plurality of the first images to the effect processing end, where a latter image transmission request is initiated after receiving the second images corresponding to the first images transmitted according to a former image transmission request.

According to one or more embodiments of the present disclosure, [Example 9] provides the method of Example 1, further including:

optionally, after responding to the effect generation request and before displaying the video, the effect processing method further includes: displaying a target interface, where at least part of the image content of at least one first image is displayed on the target interface.

According to one or more embodiments of the present disclosure, [Example 10] provides the method of Example 9, further including:

optionally, the displaying a target interface includes: processing, in a case where image resolution is inconsistent with device resolution of a display device, the first images by using a preset processing mode, and rendering the first images that have been processed on the target interface of the display device, where the preset processing mode includes interpolation processing and/or cropping processing.

According to one or more embodiments of the present disclosure, [Example 11] provides an effect processing apparatus, which includes: an effect generation request module, configured to obtain, in response to an effect generation request, a plurality of first images; a second image determining module, configured to determine a plurality of second images corresponding to the plurality of first images, respectively, where the second images are used to present shooting effects of image contents of the first images under different shooting parameters in a three-dimensional space; a video display module, configured to generate a video according to the plurality of second images, and display the video.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect processing method, comprising:
obtaining, in response to an effect generation request, a plurality of first images;
determining a plurality of second images corresponding to the plurality of first images, respectively, wherein the plurality of second images are used to present shooting effects of image contents of the plurality of first images under different shooting parameters in a three-dimensional space;
generating a video according to the plurality of second images, and displaying the video.

2. The effect processing method according to claim 1, wherein the determining a plurality of second images corresponding to the plurality of first images, respectively, comprises:
constructing, for every single first image, a three-dimensional model corresponding to the first image in a model space, and determining a target texture image corresponding to the first image, wherein the target texture image comprises a background image corresponding to the first image and the first image;
mapping the target texture image to a model surface of the three-dimensional model, and controlling a target camera in the model space to shoot the model surface using multiple shooting parameters, so as to obtain a second image corresponding to the first image.

3. The effect processing method according to claim 2, wherein the determining a target texture image corresponding to the first image comprises:
determining a background image corresponding to the first image, and splicing the background image and the first image to obtain the target texture image.

4. The effect processing method according to claim 2, wherein the constructing a three-dimensional model corresponding to the first image in a model space comprises:
determining, according to the image content of the first image, depth information corresponding to each pixel point, respectively, and constructing the three-dimensional model corresponding to the first image in the model space according to the depth information.

5. The effect processing method according to claim 1, wherein the shooting parameters comprise a shooting field of view, and a size of the shooting field of view is associated with a width-height ratio of the first image.

6. The effect processing method according to claim 5, wherein in a case where the width-height ratio of the first image is less than or equal to a preset ratio, the size of the shooting field of view is positively correlated with the width-height ratio of the first image.

7. The effect processing method according to claim 1, wherein the effect generation request is initiated from a client end; the plurality of first images are input by the client end;
the determining a plurality of second images corresponding to the plurality of first images, respectively, comprises:
transmitting the plurality of first images to an effect processing end, so that the effect processing end determines the plurality of second images corresponding to the plurality of first images, respectively;
the generating a video according to the plurality of second images comprises:
generating, in a case where a plurality of second images corresponding to the plurality of first images and fed back by the effect processing end are received, the video according to the plurality of second images, and displaying the video.

8. The effect processing method according to claim 7, wherein the transmitting the plurality of first images to an effect processing end comprises:
initiating, in a case where a count of the first images exceeds a preset transmission number, an image transmission request according to the preset transmission number, so as to transmit the plurality of the first images to the effect processing end, wherein a latter image transmission request is initiated after receiving the second images corresponding to the first images transmitted according to a former image transmission request.

9. The effect processing method according to claim 1, wherein after responding to the effect generation request and before displaying the video, the effect processing method further comprises:
displaying a target interface, wherein at least part of the image content of at least one first image is displayed on the target interface.

10. The effect processing method according to claim 9, wherein the displaying a target interface comprises:
processing, in a case where image resolution is inconsistent with device resolution of a display device, the first images by using a preset processing mode, and rendering the first images that have been processed on the target interface of the display device, wherein the preset processing mode comprises interpolation processing and/or cropping processing.

11. An electronic device, comprising:
one or a plurality of processors;
a memory, configured to store one or a plurality of programs,
wherein the one or plurality of programs, when executed by the one or plurality of processors, cause the one or plurality of processors to implement an effect processing method, comprising:
obtaining, in response to an effect generation request, a plurality of first images;
determining a plurality of second images corresponding to the plurality of first images, respectively, wherein the plurality of second images are used to present shooting effects of image contents of the plurality of first images under different shooting parameters in a three-dimensional space;
generating a video according to the plurality of second images, and displaying the video.

12. The electronic device according to claim 11, wherein the determining a plurality of second images corresponding to the plurality of first images, respectively, comprises:
constructing, for every single first image, a three-dimensional model corresponding to the first image in a model space, and determining a target texture image corresponding to the first image, wherein the target texture image comprises a background image corresponding to the first image and the first image;
mapping the target texture image to a model surface of the three-dimensional model, and controlling a target camera in the model space to shoot the model surface using multiple shooting parameters, so as to obtain a second image corresponding to the first image.

13. The electronic device according to claim 12, wherein the determining a target texture image corresponding to the first image comprises:
determining a background image corresponding to the first image, and splicing the background image and the first image to obtain the target texture image.

14. The electronic device according to claim 12, wherein the constructing a three-dimensional model corresponding to the first image in a model space comprises:
determining, according to the image content of the first image, depth information corresponding to each pixel point, respectively, and constructing the three-dimensional model corresponding to the first image in the model space according to the depth information.

15. The electronic device according to claim 11, wherein the shooting parameters comprise a shooting field of view, and a size of the shooting field of view is associated with a width-height ratio of the first image.

16. The electronic device according to claim 15, wherein in a case where the width-height ratio of the first image is less than or equal to a preset ratio, the size of the shooting field of view is positively correlated with the width-height ratio of the first image.

17. The electronic device according to claim 11, wherein the effect generation request is initiated from a client end; the plurality of first images are input by the client end;
the determining a plurality of second images corresponding to the plurality of first images, respectively, comprises:
transmitting the plurality of first images to an effect processing end, so that the effect processing end determines the plurality of second images corresponding to the plurality of first images, respectively;
the generating a video according to the plurality of second images comprises:
generating, in a case where a plurality of second images corresponding to the plurality of first images and fed back by the effect processing end are received, the video according to the plurality of second images, and displaying the video.

18. The electronic device according to claim 17, wherein the transmitting the plurality of first images to an effect processing end comprises:
initiating, in a case where a count of the first images exceeds a preset transmission number, an image transmission request according to the preset transmission number, so as to transmit the plurality of the first images to the effect processing end, wherein a latter image transmission request is initiated after receiving the second images corresponding to the first images transmitted according to a former image transmission request.

19. The electronic device according to claim 11, wherein after responding to the effect generation request and before displaying the video, the effect processing method further comprises:
displaying a target interface, wherein at least part of the image content of at least one first image is displayed on the target interface.

20. A non-transitory computer-readable storage medium containing computer-executable instructions, wherein the computer-executable instructions, when executed by a computer processor, are used to execute an effect processing method, comprising:
obtaining, in response to an effect generation request, a plurality of first images;
determining a plurality of second images corresponding to the plurality of first images, respectively, wherein the plurality of second images are used to present shooting effects of image contents of the plurality of first images under different shooting parameters in a three-dimensional space;
generating a video according to the plurality of second images, and displaying the video.
